(19) United States
(12) Patent Application Publication
(10) Pub. No.: US 2015/0281681 A1
(43) Pub. Date: Oct. 1, 2015

(54) DEVICE FOR PROJECTING SUPER MULTI-VIEW IMAGE AND METHOD THEREOF

(71) Applicant: ELECTRONICS AND TELECOMMUNICATIONS RESEARCH INSTITUTE, Daejeon (KR)

(72) Inventors: Beom Ryeol LEE, Daejeon (KR); Jeung Chul PARK, Daejeon (KR); Il Kwon JEONG, Daejeon (KR)

(21) Appl. No.: 14/633,637

(22) Filed: Feb. 27, 2015

(30) Foreign Application Priority Data
Mar. 27, 2014 (KR) 10-2014-0036161

(51) Int. Cl. H04N 13/04; G02B 26/02; G02B 26/08; G02B 27/22

(52) U.S. Cl. CPC H04N 13/0445; G02B 27/2264; G02B 26/02; G02B 26/0833; H04N 13/0497; G02B 5/04

(57) ABSTRACT

There are provided a device for projecting a super multi-view image that provides an image of two views to a user's pupil and a method thereof. A device for projecting a super multi-view image according to an embodiment of the present invention includes an operating unit configured to receive super multi-view image content and transmit the received super multi-view image content and a driving signal, and a control unit driven by the driving signal received from the operating unit and configured to divide the received super multi-view image content into a plurality of single-view images, load the divided single-view images in a high speed image display device, and transmit an open command signal to an active shutter corresponding to the single-view image loaded in the high speed image display device among an active shutter array.

### CROSS-REFERENCE TO RELATED APPLICATION

This application claims priority to and the benefit of Korean Patent Application No. 10-2014-0036161, filed on Mar. 27, 2014, the disclosure of which is incorporated herein by reference in its entirety.

### BACKGROUND

1. Field of the Invention

The present invention relates to a device for projecting a super multi-view image that provides an image of at least two views to a user's pupil and a method thereof.

2. Discussion of Related Art

Super multi-view display technology provides an image of at least two views to a user's pupil and enables a display device to project an image of a plurality of views to a pupil.

A multi-view type 3D display in the related art provides a sense of depth to the user using binocular parallax which results in both eyes viewing different images. An image itself projected to one eye is a 2D image and focus accommodation of one eye focuses on a display panel surface rather than a depth of a 3D image. Therefore, when binocular parallax and focus accommodation of one eye do not coincide, stereoscopic observation fatigue may be caused.

A super multi-view 3D display relates to technology in which an interval between views is adjusted to be compact, a multi-view image is projected to one eye, and focus accommodation of eyes is adjusted to coincide to a depth surface in addition to binocular parallax.

In general, technology for producing and displaying super multi-view image content may be divided into three fields, technology for obtaining a super multi-view image, technology for creating a multi-view image in order to display the obtained view image and generating super multi-view image content, and technology for display device adaptive conversion in order to display the super multi-view image content.

In technology for obtaining a super multi-view image, a method in which a view image is obtained through a plurality of cameras, an intermediate image between view images is obtained by a calculation method using a combination of adjacent view images, and depth information is extracted to generate each view image is proposed.

In order to display each view image as a super multi-view image, technology for determining a method of creating a super multi-view image for each field of vision is necessary for the user. Therefore, in order to display the super multi-view image in a glasses-free method, a lenticular lens method or a method of using a parallax barrier is used.

As a method of displaying a multi-view image or a super multi-view image in the related art, a method of using an array configuration of a plurality of projectors or extending display technology for a multi-view image or an integrated image was provided. However, there is a problem in that constraint conditions of the number of view images for satisfying conditions of an empirical super multi-view image are not explicitly provided.

### SUMMARY OF THE INVENTION

The present invention provides a device for projecting a super multi-view image to a user's pupil by synchronizing a high speed image display device with an active shutter array and a method thereof.

According to an aspect of the present invention, there is provided a device for projecting a super multi-view image. The device includes an operating unit configured to receive super multi-view image content and transmit the received super multi-view image content and a driving signal, and a control unit driven by the driving signal received from the operating unit and configured to divide the received super multi-view image content into a plurality of single-view images, load the divided single-view images in a high speed image display device, and transmit an open command signal to an active shutter corresponding to the single-view image loaded in the high speed image display device among an active shutter array.

According to another aspect of the present invention, there is provided a binocular device for projecting a super multi-view image. The device includes a first super multi-view image projection module configured to sequentially load a single-view image in a predetermined first single-view image group among a plurality of single-view images in a first high speed image display device, open a first active shutter array of the loaded single-view image, and project the single-view image, and a second super multi-view image projection module configured to sequentially load a single-view image in a second single-view image group among the plurality of single-view images in a second high speed image display device, open a second active shutter array of the single-view image loaded in the second high speed image display device, and project the single-view image.

According to still another aspect of the present invention, there is provided a method of projecting a super multi-view image. The method includes synchronizing a view in which a high speed image display device displays a plurality of single-view images that are images of each view of a super multi-view image with an opening time interval of an active shutter corresponding to the plurality of single-view images among an active shutter array, setting synchronization information of the active shutter that is open for each of the plurality of single-view images of the super multi-view image, loading the single-view image in the high speed image display device, and displaying the single-view image by opening the active shutter corresponding to the loaded single-view image.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a device for projecting a super multi-view image according to an embodiment of the present invention;

FIG. 2 is a diagram illustrating a binocular device for projecting a super multi-view image according to an embodiment of the present invention;

FIG. 3 is a diagram illustrating a timing diagram of an active shutter array and a high speed image display device according to an embodiment of the present invention;

FIG. 4 is a conceptual diagram illustrating a view image provided to each eye of a user through an active shutter array according to an embodiment of the present invention; and

FIG. 5 is a flowchart illustrating a method of projecting a super multi-view image according to an embodiment of the present invention.

### DETAILED DESCRIPTION OF EXEMPLARY EMBODIMENTS

Hereinafter, exemplary embodiments of the present invention will be described in detail with reference to diagrams.

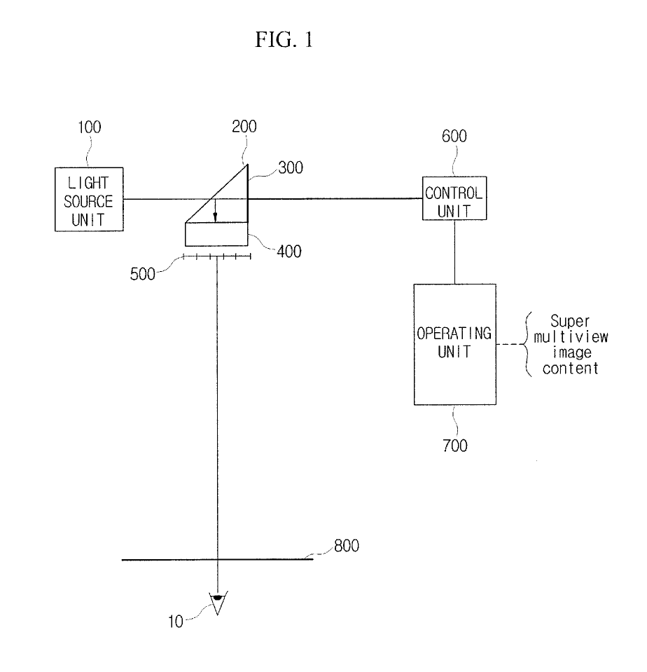

FIG. 1 is a diagram illustrating a device for projecting a super multi-view image according to an embodiment of the present invention.

As illustrated in FIG. 1, a device for projecting a super multi-view image includes an operating unit 700 configured to receive super multi-view image content and transmit the received super multi-view image content and a driving signal, and a control unit 600 driven by the driving signal and configured to divide the received super multi-view image content into a plurality of single-view images, load the single-view image in a high speed image display device 300, and transmit an open command signal to an active shutter corresponding to the single-view image loaded in the high speed image display device 300 among an active shutter array 500.

The high speed image display device 300 is a digital micro-mirror device (DMD) that is a type of a spatial light modulator (SLM) and is a reflex device in which a fine mirror is on a semiconductor.

The digital micro-mirror has about 2 million fine mirrors that adjust their slopes to change a reflection direction of incident light such that each pixel is controlled to be turned on or off. Each micro-mirror corresponds to each pixel, and it is appropriate to process a video having a high quality and high brightness.

The device for projecting a super multi-view image according to an embodiment of the present invention uses the high speed image display device 300 serving as a digital micro-mirror capable of displaying a high speed image, and provides a single-view image that is an image of each view of super multi-view image content to the user. Therefore, an image of at least two views is provided to the user's pupil and the super multi-view image may be viewed.

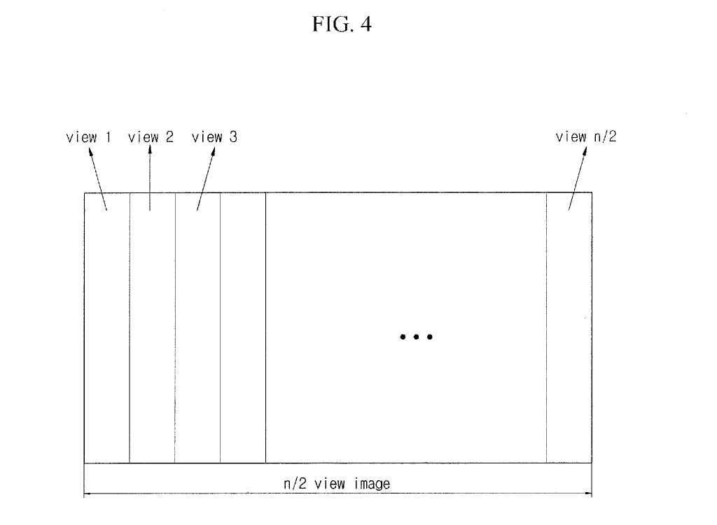

The control unit 600 sequentially loads a plurality of single-view images in the high speed image display device 300 serving as a digital micro-mirror. As illustrated in FIG. 4, the control unit sequentially loads a plurality of single-view images (view 1, view 2, . . . , and view n/2) in the digital micro-mirror.

Also, as illustrated in FIG. 1, the control unit 600 uses a light source unit 100, a prism 200, a projection objective lens 400, the active shutter array 500, and a projection screen 800, performs control such that the single-view images sequentially loaded in the digital micro-mirror are projected, and provides the super multi-view image to the user.

The control unit 600 transmits a refraction angle control signal to a reflective device included in the high speed image display device 300 serving as a digital micro-mirror device. The refraction angle control signal is a control signal for adjusting a slope of the fine mirror included in the digital micro-mirror 300 when each single-view image is loaded.

In order to provide the super multi-view image to one of the user's eyes, the control unit 600 synchronizes a time interval in which the high speed image display device 300 serving as a digital micro-mirror device displays the single-view image with an opening time interval of the active shutter of the active shutter array 500 corresponding to the displayed single-view image.

In this case, the control unit 600 synchronizes a display view for each single-view image and transmits the open command signal to the active shutter. According to set synchronization information, only the active shutter corresponding to the single-view image loaded in the high speed image display device 300 serving as a digital micro-mirror device among the active shutter array 500 is open and a corresponding single-view image is displayed.

In order to provide the super multi-view image to the user and provide a display of an image sequence more than a predetermined number of times (for example, 30 times) per second, the control unit 600 performs control such that an operation period of the active shutter array 500 which is a sum value of active shutter opening time intervals of single-view images is set to a predetermined value or less.

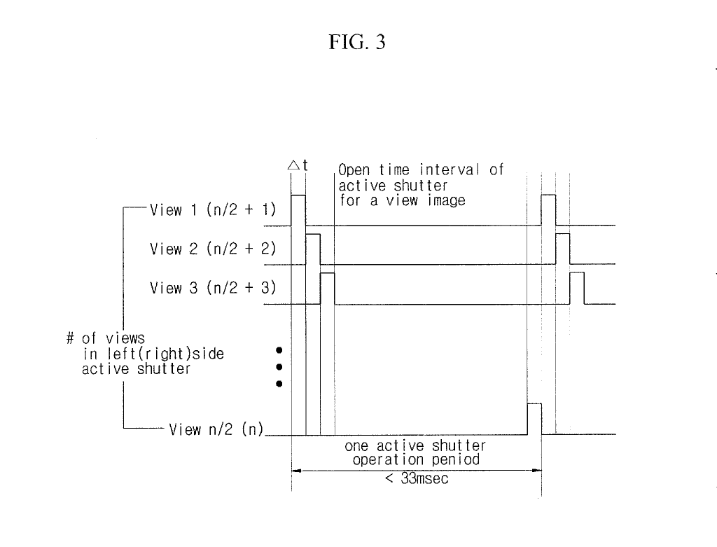

In an embodiment, as illustrated in FIG. 3, the control unit 600 sets an operation period (one active shutter operation period) of the single active shutter array to below 33 msec and transmits the open command signal to the active shutter.

The device for projecting a super multi-view image according to the embodiment of the present invention displays the view image loaded in the high speed image display device 300 through a projection optical system including the light source unit 100 configured to provide light incident to the high speed image display device 300, the prism 200 configured to refract light provided from the light source unit 100, and the projection objective lens 400 configured to project light refracted by the prism 200 and the single-view image.

In this case, the device for projecting a super multi-view image according to the embodiment of the present invention further includes the projection screen 800 configured to sequentially project the single-view image displayed by synchronizing it with an opening time of the active shutter. The user may view the super multi-view image created by a field of vision.

Preferably, the projection screen 800 is a screen using a design of a Fresnel lens. The Fresnel lens is a lens that is designed to have a large diameter and a small focal length and have a lighter weight and a smaller volume than a general lens in the related art. The Fresnel lens is thinner, lighter, and transmits more light than lens having the same diameter in the related art.

In the device for projecting a super multi-view image according to the embodiment of the present invention, as illustrated in FIG. 1, the active shutter array 500 is provided between the projection objective lens 400 and the projection screen 800, and sequentially displays each single-view image passing through the active shutter that is sequentially open according to the open command signal received from the control unit 600 on the projection screen 800.

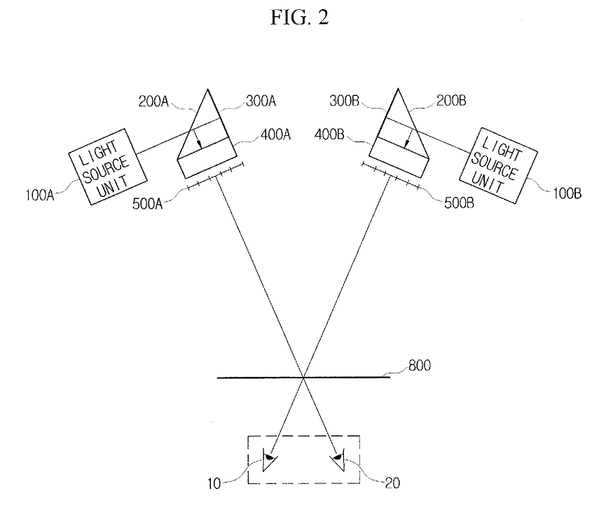

FIG. 2 is a diagram illustrating a binocular device for projecting a super multi-view image according to another embodiment of the present invention. As illustrated in FIG. 2, the binocular system for projecting a super multi-view image includes a first super multi-view image projection module and a second super multi-view image projection module. The first super multi-view image projection module sequentially loads a single-view image in a predetermined First single-view image group among a plurality of single-view images in a first high speed image display device 300A, opens a first active shutter array 500A of the loaded single-view image, and projects the single-view image. The second super multi-view image projection module sequentially loads a single-view image in a second single-view image group among the plurality of single-view images in a second high speed image display device 300B, opens a second active shutter array 500B of the single-view image loaded in the second high speed image display device 300B, and projects the single-view image.

The plurality of single-view images are single-view images included in the super multi-view image content. The binocular system for projecting a super multi-view image according to the present invention displays the single-view images to the user's both eyes and provides the super multi-view image to the user.

As illustrated in FIG. 2, the first and second super multi-view image projection modules are symmetrically disposed based on a virtual center line bisecting an angle formed of fields of vision of a right-eye 20 and a left-eye 10 of the user. The first and second super multi-view image projection modules for displaying the super multi-view image to each eye are symmetrically disposed as illustrated in FIG. 2. Therefore, it is possible to provide the super multi-view image to the user's both eyes, and provide a compact binocular device for projecting a super multi-view image.

The first and second high speed image display devices 300A and 300B of the first and second super multi-view image projection modules include a digital micro-mirror. As illustrated in FIG. 3, the first super multi-view image projection module corresponding to the user's right-eye sequentially loads each single-view image included in the first single-view image group (view 1, view 2, view 3, . . . , and view n/2) among the plurality of single-view images in the first high speed image display device 300A. The second super multi-view image projection module corresponding to the user's left-eye sequentially loads each single-view image included in the second single-view image group (view n/2+1, view n/2+2, view n/2+3, . . . , and view n) in the second high speed image display device 300B.

The term “Δt” denoted in FIG. 3 refers to a time interval in which the active shutter is open for a single-view image. An operation period of a single active shutter that is a sum value of these time intervals is set to 33 msec or less, and thus the user may view the super multi-view image.

The first and second super multi-view image projection modules transmit a refraction angle control signal to the first and second high speed image display devices 300A and 300B and project each single-view image loaded in the first and second high speed image display devices 300A and 300B. The first and second high speed image display devices 300A and 300B including the digital micro-mirror are driven by the received refraction angle control signal when the single-view image is loaded and display the loaded single-view image.

As illustrated in FIG. 3, in the first and second image display devices, synchronization is performed according to multiplexing of the super multi-view image and a timing diagram of the active shutter array. The first and second super multi-view image projection modules synchronize single-view image display views of the first and second high speed image display devices 300A and 300B with opening times of the first and second active shutter arrays 500A and 500B.

Also, an opening time of the first active shutter array 500A and an opening time of the second active shutter array 500B are synchronized. The single-view images (view 1, view 2, view 3, . . . , and view n/2) displayed by the first super multi-view image projection module and the single-view images (view n/2+1, view n/2+2, view n/2+3, . . . , and view n) displayed by the second super multi-view image projection module are synchronized and displayed.

As illustrated in FIG. 4, each of the active shutter arrays of the first and second super multi-view image projection modules disposes the view image in a horizontal direction based on the user's both eyes and divides and displays each image to the user's both eyes.

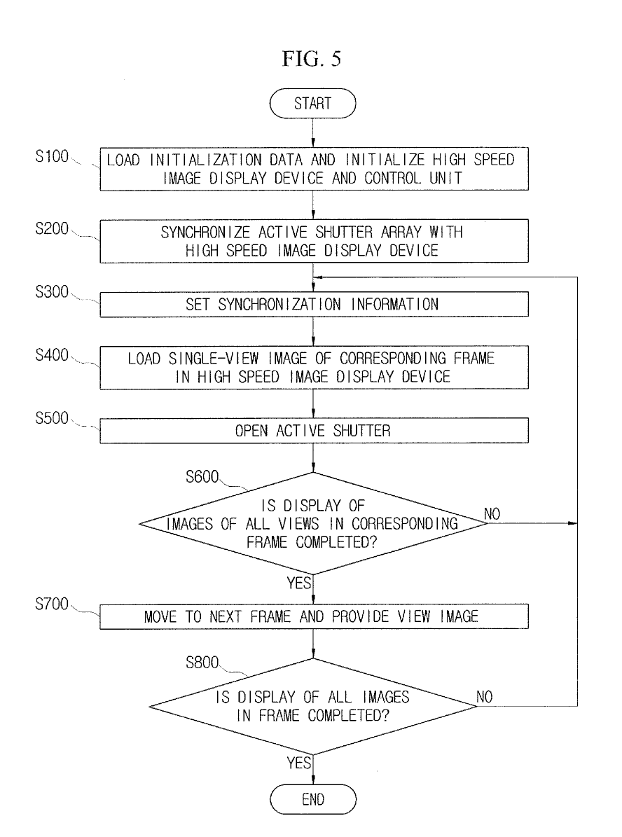

FIG. 5 is a flowchart illustrating a method of projecting a super multi-view image according to another embodiment of the present invention. As illustrated in FIG. 5, the method of projecting a super multi-view image includes an operation of synchronizing (S200) a view in which the high speed image display device displays a plurality of single-view images that are images of each view of the super multi-view image with an opening time of an active shutter corresponding to the plurality of single-view images among the active shutter array, an operation of setting synchronization information (S300) of the active shutter which is open for each of the plurality of single-view images of the super multi-view image, an operation of loading (S400) the single-view image in the high speed image display device, and an operation of displaying (S500) the single-view image by opening the active shutter corresponding to the loaded single-view image.

A method of projecting a super multi-view image according to still another embodiment of the present invention further includes an operation (S100) of receiving a driving signal and initializing a control unit configured to control the high speed image display device and operations of the high speed image display device before the operation of synchronizing (S200).

When driving of the device for projecting a super multi-view image starts, in the operation of initializing (S100), initialization data is loaded in the high speed image display device, a control board device of the high speed image display device connected to a driving computer of the device for projecting a super multi-view image is initialized, and an image display control setting value that is previously stored for each single-view image is initialized.

The high speed image display device is a digital micro-mirror device (DMD) that is a reflex device in which a fine mirror is on a semiconductor.

In the operation of synchronizing (S200), a view in which the digital micro-mirror displays the single-view image according to the refraction angle control signal transmitted to the digital micro-mirror and an opening time of the active shutter that projects the single-view image are synchronized. In the operation of setting synchronization information (S300), an operation period of the active shutter array that is a sum value of active shutter opening time intervals is set to a predetermined value or less (for example: 33 msec).

In the operation of loading the single-view image (S400), the single-view images are sequentially loaded in the digital micro-mirror. That is, in the operation of synchronizing (S200) and the operation of setting synchronization information (S300), according to the set synchronization information, the digital micro-mirror transmits a control signal for adjusting a slope of a fine mirror of the digital micro-mirror for each single-view image.

Also, after receiving the control signal, the digital micro-mirror adjusts a slope of the fine mirror and displays the loaded single-view image. In this case, the opening time of the active shutter is synchronized with a display view of each single-view image, the active shutter corresponding to the loaded single-view image is open, and the loaded single-view image is displayed.

The operation of displaying the single-view image (S500) further includes an operation of determining (S600) whether display of the single-view image in the foremost frame among a plurality of frames constituting the super multi-view image is completed, and an operation of sequentially displaying a single-view image (S700) included in a frame subsequent to the foremost frame when the display of the single-view image in the foremost frame is completed.

When the display of the single-view image in the foremost frame is not completed, the process returns to the operation of setting synchronization information (S300) on the single-view image for which display is not completed. The operation of displaying the single-view image by opening of the active shutter is repeated (S500) until display of the single-view image in the frame is completed and projection of the super multi-view image received by a driving device is completed (S800).

Also, a method of projecting a super multi-view image according to still another embodiment of the present invention is a method of projecting a super multi-view image to one of the user's eyes. The method of projecting a super multi-view image may be independently applied to the user's left-eye and right-eye. In this case, preferably, the method further includes an operation of synchronizing an opening time of the active shutter that divides and displays the single-view image to the left-eye and the right-eye.

According to the device and method for projecting a super multi-view image of the present invention, it is possible to display a super multi-view image by creating a field of vision of the super multi-view image and using a super multi-view image display device.

An image of at least two views is provided to the user's pupil, conditions of a super multi-view image display are satisfied, and the user may view the super multi-view image in a glasses-free method.

Unlike a method of providing a super multi-view image by extending a multi-view image using a plurality of projectors in the related art, an image display device operating at a high speed such as a digital micro-mirror device (DMD) and an active shutter array are used to display the super multi-view image. Accordingly, it is possible to implement a super multi-view image display having a simple structure compared to multi-projector methods in the related art.

It is possible to provide a monocular device for projecting a super multi-view image having a compact configuration. When a left-eye image display device and a right-eye image display device are symmetrically designed, it is possible to simplify a configuration of a binocular system for projecting a super multi-view image and contribute to commercializing of the device for projecting a super multi-view image having a compact configuration.

According to the device and method for projecting a super multi-view image, it is possible to display a super multi-view image that provides consecutive parallax in a horizontal direction. The present invention may be applied to a next generation 3D stereoscopic image display environment to the extent that the user may view the real world at an advanced level from a binocular stereoscopic image or a multi-view image.

Therefore, additional effects of dramatically expanding a market size of 3D stereoscopic image content may be expected. Expansion of related markets and derivatives markets may also be expected.

Effects of the present invention are not limited to the above-described effects, and other unmentioned effects may be clearly understood by those skilled in the art from the following descriptions.

While the present invention has been particularly described with reference to exemplary embodiments, it will be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and will be construed as being included in the present invention.

[Reference Numerals]

| | |
|---|---|
| 10: left-eye | 20: right-eye |
| 100: light source unit | 200: prism |
| 300: high speed image display device | 400: projection objective lens |
| 500: active shutter array | 600: control unit |
| 700: operating unit | 800: projection screen |

What is claimed is:

1. A device for projecting a super multi-view image, comprising:
an operating unit configured to receive super multi-view image content and transmit the received super multi-view image content and a driving signal; and
a control unit driven by the driving signal received from the operating unit and configured to divide the received super multi-view image content into a plurality of single-view images, load the divided single-view images in a high speed image display device, and transmit an open command signal to an active shutter corresponding to the single-view image loaded in the high speed image display device among an active shutter array.

2. The device according to claim 1,
wherein the control unit sequentially loads the plurality of single-view images in the image display device serving as a digital micro-mirror.

3. The device according to claim 2,
wherein the control unit transmits a refraction angle control signal to a reflective device included in the digital micro-mirror.

4. The device according to claim 2,
wherein the control unit synchronizes a time interval in which the digital micro-mirror displays the single-view image with an opening time interval of an active shutter corresponding to the displayed single-view image, and transmits an open command signal to the synchronized active shutter when the digital micro-mirror displays the single-view image.

5. The device according to claim 4,
wherein the control unit performs control such that an operation period of the active shutter array that is a sum value of the active shutter opening time intervals is set to a predetermined value or less and provides the super multi-view image content to a user.

6. The device according to claim 2, further comprising:
a light source unit configured to provide light incident to the digital micro-mirror;
a prism configured to refract light provided from the light source unit; and
a projection objective lens configured to project light refracted by the prism and the single-view image.

7. The device according to claim 6, further comprising
a projection screen configured to sequentially project a single-view image displayed by synchronizing it with an opening time interval of the active shutter and provide a super multi-view image to the user's field of vision.

8. The device according to claim 7,
wherein the active shutter array is provided between the projection objective lens and the projection screen and displays the single-view image passing through the active shutter that is sequentially open according to the received open command signal on the projection screen.

9. A binocular device for projecting a super multi-view image, comprising
a first super multi-view image projection module configured to sequentially load a single-view image in a predetermined first single-view image group among a plurality of single-view images in a first high speed image display device, open a first active shutter array of the loaded single-view image, and project the single-view image; and
a second super multi-view image projection module configured to sequentially load a single-view image in a second single-view image group among the plurality of single-view images in a second high speed image display device, open a second active shutter array of the single-view image loaded in the second high speed image display device, and project the single-view image.

10. The binocular device according to claim 9,
wherein the first and second super multi-view image projection modules load the single-view image in the first and second high speed image display devices serving as a digital micro-mirror.

11. The binocular device according to claim 10,
wherein the first and second super multi-view image projection modules transmit a refraction angle control signal to the first and second high speed image display devices and project each single-view image loaded in the first and second high speed image display devices.

12. The binocular device according to claim 10,
wherein the first and second super multi-view image projection modules synchronize a display view of the single-view image of the first and second high speed image display devices with opening time intervals of the first and second active shutter arrays.

13. The binocular device according to claim 12,
wherein the first and second super multi-view image projection modules synchronize the opening time interval of the first active shutter array and the opening time interval of the second active shutter array.

14. The binocular device according to claim 9,
wherein the first and second super multi-view image projection modules are symmetrically disposed based on a virtual center line bisecting an angle formed of fields of vision of a left-eye and a right-eye of a user.

15. A method of projecting a super multi-view image, comprising:
synchronizing a view in which a high speed image display device displays a plurality of single-view images that are images of each view of a super multi-view image with an opening time interval of an active shutter corresponding to the plurality of single-view images among an active shutter array;
setting synchronization information of the active shutter that is open for each of the plurality of single-view images of the super multi-view image;
loading the single-view image in the high speed image display device; and
displaying the single-view image by opening the active shutter corresponding to the loaded single-view image.

16. The method according to claim 15,
wherein, in the setting of the synchronization information, an operation period of the active shutter array that is a sum value of active shutter opening time intervals is set to a predetermined value or less.

17. The method according to claim 16,
wherein, in the loading of the single-view image, the single-view images are sequentially loaded in the digital micro-mirror.
